(19) United States
(12) Patent Application Publication
(10) Pub. No.: US 2009/0091778 A1
(43) Pub. Date: Apr. 9, 2009

(54) System and Method for Printing Forms

(76) Inventors: Evan Greer Adams, Lexington, KY (US); Andrew Charles Donovan, Lexington, KY (US); Jason M. Hansen, Winchester, KY (US); Kenneth Ray Woodruff, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/868,270

(22) Filed: Oct. 5, 2007

(51) Int. Cl. G06F 3/12

(52) U.S. Cl. 358/1.15

(57) ABSTRACT

A method, computer program product, and printing system for selecting an identifier chosen from a plurality of identifiers defined within a storage device of a printing system. A form is selected that is chosen from a plurality of forms defined within the storage device of the printing system. The selected form is modified to associate the selected form with the selected identifier, thus defining a modified selected form.

### TECHNICAL FIELD

This disclosure relates to printing devices and, more particularly, to printing devices for printing forms.

### BACKGROUND

The impact of paper-based processes is at the heart of the debate over how information technology may prevent medical mistakes, reduce costs, and improve care. Most of the attention is focused on the development of structured electronic medical records and applications, such as computerized physician order entry (CPOE). While the debate over electronic medical records continues to drag on and clinicians are slow to adopt new technologies, paper-based processes may continue to impact care. According to CapGemini, 95% of all physician orders are still written manually. PriceWaterhouseCoopers reports “paperwork adds at least 30 minutes to every hour of patient care and, in some settings, adds an hour of paperwork to every hour of patient care.”

The vision for the future is a “paperless” clinical information system in which information may be accessed anytime from anywhere through wireless devices such as tablet PCs or mobile PC carts. However, a typical hospital today may use over three-thousand pre-printed paper forms that drive clinical processes in virtually every area of the hospital. Accordingly, paper may most likely continue to be used as a medium for capturing information, and the first step in migrating to electronic medical records may be the implementation of on-demand electronic forms.

### SUMMARY OF DISCLOSURE

In an implementation, a method includes selecting an identifier chosen from a plurality of identifiers defined within a storage device of a printing system. A form is selected that is chosen from a plurality of forms defined within the storage device of the printing system. The selected form is associated with the selected identifier, thus defining a modified selected form.

One or more of the following features may be included. The modified selected form may be printed on the printing system. The plurality of identifiers may be defined within at least a portion of an information database included within the storage device of the printing system. The at least a portion of the information database may be obtained from a remote network storage device.

The plurality of forms may be defined within at least a portion of a forms database included within the storage device of the printing system. The at least a portion of the forms database may be obtained from a remote network storage device.

The storage device of the printing system may be an internal storage device included within the printing system.

Modifying the selected form may include at least one of modifying the selected form to include information associated with the selected identifier within at least one populatable field within the selected form, and modifying the selected form to include a machine readable barcode associated with the selected identifier.

In another implementation, a computer program product resides on a computer readable medium that has a plurality of instructions stored on it. When executed by a processor, the instructions cause the processor to perform operations including selecting an identifier chosen from a plurality of identifiers defined within a storage device of a printing system. A form is selected that is chosen from a plurality of forms defined within the storage device of the printing system. The selected form is associated with the selected identifier, thus defining a modified selected form.

One or more of the following features may be included. The modified selected form may be printed on the printing system. The plurality of identifiers may be defined within at least a portion of an information database included within the storage device of the printing system. The at least a portion of the information database may be obtained from a remote network storage device.

The plurality of forms may be defined within at least a portion of a forms database included within the storage device of the printing system. The at least a portion of the forms database may be obtained from a remote network storage device.

The storage device of the printing system may be an internal storage device included within the printing system.

Modifying the selected form may include at least one of modifying the selected form to include information associated with the selected identifier within at least one populatable field within the selected form, and modifying the selected form to include a machine readable barcode associated with the selected identifier.

In another implementation, a printing system includes a storage device for defining a plurality of identifiers and a plurality of forms. A user interface is configured to allow a user to select a patient identifier chosen from the plurality of patient identifiers defined within the storage device of the printing system and select a form chosen from the plurality of forms defined within the storage device of the printing system. Processing logic is configured to associate the selected form with the selected identifier, thus defining a modified selected form.

One or more of the following features may be included. The plurality of forms may be defined within at least a portion of a forms database included within the storage device of the printing system. A network interface may be configured to interface with a distributed computing network and obtain the at least a portion of the forms database from a remote network storage device.

The processing logic may be further configured to perform at least one of modifying the selected form to include information associated with the selected identifier within at least one populatable field within the selected form, and modifying the selected form to include a machine readable barcode associated with the selected identifier.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a forms management process executed by a printing system coupled to a distributed computing network;

FIG. 2 is a diagrammatic view of the printing system of FIG. 1;

FIG. 3 is a flowchart of the forms management process of FIG. 1; and

FIG. 4 is a diagrammatic view of a display screen rendered by the forms management process of FIG. 1.

Like reference symbols in the various drawings indicate like elements.

### DETAILED DESCRIPTION

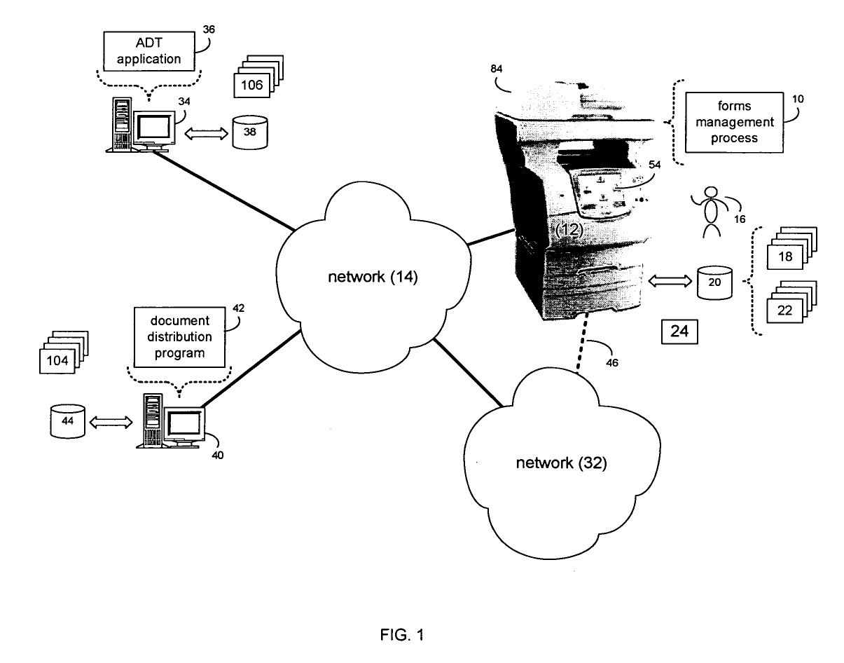

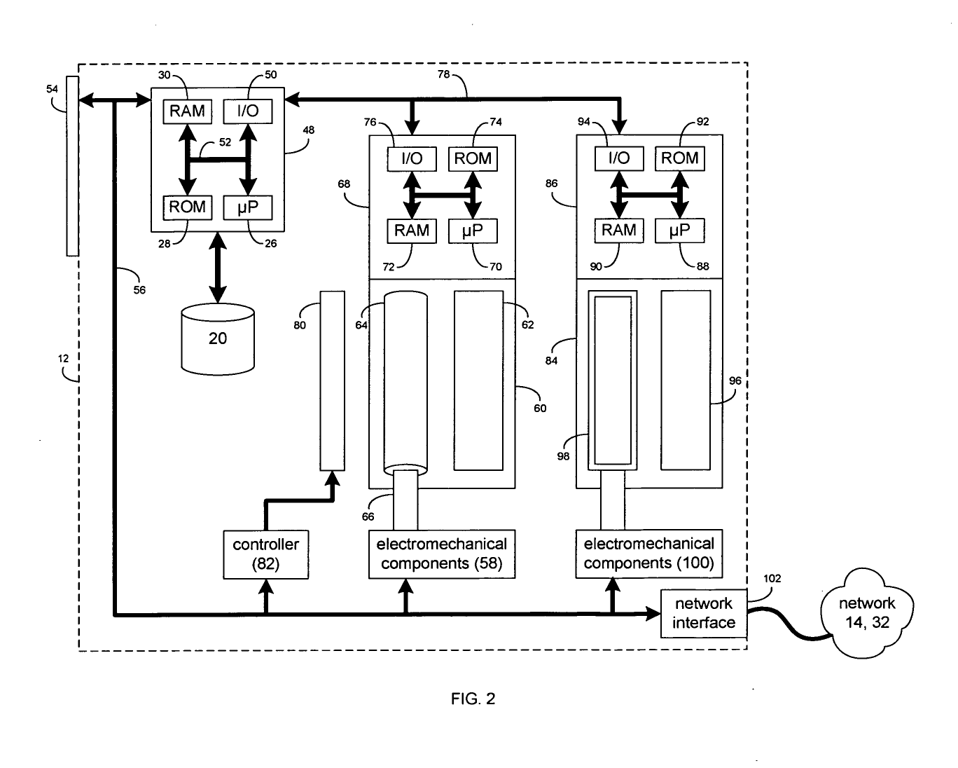

Referring to FIGS. 1-2, there is shown a forms management process 10 that may reside on and may be executed by printing device or system 12, which may be connected to a network 14, such as the Internet or a wide or local area network. Examples of printing system 12 may include, but are not limited to, an inkjet printing system, a laser printing system, and a multifunction printing system. Examples of such a multifunction printing system are a Lexmark X850e and a Lexmark X646e, both of which are available from Lexmark International of Lexington, Ky.

As will be discussed below in greater detail, forms management process 10 may allow a user 16 to select an identifier chosen from a plurality of identifiers 18, which are defined within storage device 20 of printing system 12. User 16 may also select a form that is chosen from a plurality of forms 22, which are defined within storage device 20 of printing system 12. The selected form may be modified to associate the selected form with the selected identifier, thus defining a modified selected form 24.

The instruction sets and subroutines of forms management process 10, which may be stored on storage device 20 coupled to printing system 12, may be executed by one or more processors (e.g., microprocessor 26) and one or more memory architectures (e.g., read-only memory (ROM) 28, random access memory (RAM) 30) incorporated into printing system 12. Storage device 20 may be an internal storage device included within printing system 12. Examples of storage device 20 may include, but are not limited to, a hard disk drive, a tape drive, an optical drive, a RAID array, RAM, ROM, a compact flash (CF) storage device, a secure digital storage device, and a memory stick storage device. Printing system 12 may execute an operating system, examples of which may include but are not limited to a Unix™ based operating system and a Linux™ based operating system.

Network 14 may be coupled to one or more secondary networks (e.g., network 32), examples of which may include, but are not limited to, a local area network, a wide area network, or an intranet.

Server computer 34 may execute an industry specific application 36, which manages and provides access to information required by end users to perform a workflow process. For example, in the healthcare industry, an Admission Discharge and Transfer (i.e., ADT) application that tracks the status of various patients as they are treated within a healthcare facility, such as a hospital or a long term care facility, may be run on server computer 34. The instruction sets and subroutines of application 36, which may be stored on storage device 38 coupled to server computer 34, may be executed by one or more processors (not shown) and one or more memory architectures (not shown) incorporated into server computer 34. Server computer 34, which may provide information or services to or perform functions for client devices, such as other computers or printing devices, on the network may be implemented as is known in the art. Server computer 34 may be a web server (or a series of servers) running a network operating system, examples of which may include, but are not limited to, Microsoft Windows XP Server™; Novell Netware™; or Red Hat Linux™.

Server computer 34 may communicate with server computer 40 using one or more protocols. For example, in the healthcare industry, Health Level 7 (HL7) is a universal protocol used within the healthcare industry for formatting, transmitting and receiving data. Server computer 40 may execute a document distribution application or program 42, such as the Lexmark Document Distributor (i.e., LDD) application that allows for the distribution of electronic forms. The instruction sets and subroutines of document distribution program 42, which may be stored on a storage device 44 coupled to server computer 40, may be executed by one or more processors (not shown) and one or more memory architectures (not shown) incorporated into server computer 40.

Server computers 34, 40 may access printing system 12 directly through network 14 or through secondary network 32. Server computer 40, which may provide information or services to or perform functions for client devices, such as other computers or printing devices, on the network may be implemented as is known in the art. Server computer 40 may be a web server (or a series of servers) running a network operating system, examples of which may include, but are not limited to, Microsoft Windows XP Server™, Novell Netware™, or Red Hat Linux™. Further, printing system 12 may be connected to network 14 through secondary network 32, as illustrated with phantom link line 46.

Printing system 12 may include system board 48 for controlling the operation of printing system 12. System board 48 may include microprocessor 26, ROM 28, RAM 30, and an input/output (I/O) controller 50. Microprocessor 26, ROM 28, RAM 30, and I/O controller 50 may be coupled to each other via a data bus 52.

Printing system 12 may include display panel 54 for rendering a graphical user interface and providing information to user 16. Display panel 54 may include a liquid crystal display panel, one or more light emitting diodes, and one or more switches. Display panel 54 may be coupled to I/O controller 50 of system board 48 via a data bus 56. Examples of data bus 52, 56 may include, but are not limited to, a Peripheral Component Interconnect (PCI) bus, an Industry Standard Architecture (ISA) bus, or a proprietary bus.

Printing system 12 may include electromechanical components 58 for controlling the movement of paper through printing system 12. Examples of electromechanical components 58 may include, but are not limited to, feed motors (not shown), gear drive assemblies (not shown), paper jam sensors (not shown), and paper feed guides (not shown). Electromechanical components 58 may be coupled to system board 48 via data bus 56.

Printing system 12 may include printer cartridge 60. Printer cartridge 60 may include a toner reservoir 62 and a toner drum assembly 64. Electromechanical components 58 may be mechanically coupled to printer cartridge 60 via a releasable gear assembly 66 that allows printer cartridge 60 to be easily removed from printing system 12.

Printer cartridge 60 may include system board 68 that controls the operation of printer cartridge 60. System board 68 may include a microprocessor 70, RAM 72, ROM 74, and I/O controller 76. System board 68 may be releasably coupled to system board 48 via a data bus 78, thus allowing for the removal of printer cartridge 60 from printing system 12. Examples of data bus 78 may include but are not limited to a PCI bus, an ISA bus, an Inter-IC (I2C) bus, a Serial Peripheral Interconnect (SPI) bus, or a proprietary bus.

Printing system 12 may include a fusing device 80 for affixing the toner supplied by toner reservoir 62 and applied by toner drum assembly 64 to the media (e.g., paper) being processed by printing system 12. The temperature of fusing device 80 may be controlled by a controller 82. Controller 82 may be coupled to system board 48 via data bus 56. Alternatively, controller 82 may be incorporated into system board 48.

Printing system 12 may include a scanner assembly 84 for scanning documents. Scanner assembly 84 may include a system board 86 that controls the operation of scanner assembly 84. System board 86 may include a microprocessor 88, RAM 90, ROM 92, and I/O controller 94. System board 86 may be coupled to system board 48 via data bus 78. Scanner assembly 84 may include a light source 96 and a light receptor 98, such as one or more charge coupled devices. Electromechanical components 100 may move the document being scanned with respect to light source 96 and light receptor 98. Alternatively, electromechanical components 100 may move light source 96 and light receptor 98 with respect to the document being scanned. Printing system 12 may include network interface 102 for allowing printing system 12 to interface with e.g., networks 14, 32 and obtain information from one or more remote network storage devices (e.g., storage device 38 coupled to server computer 34 and/or storage device 44 coupled to server computer 40). For example, in the healthcare industry, such information may include a plurality of patient identifiers 18 and/or plurality of healthcare forms 22.

Using the healthcare industry as an example, the forms management process 10 for printing system 12 will be described as it may be used in a healthcare facility environment, such as a hospital. However, as will be appreciated by one of ordinary skill in the art, the forms management process 10 is not limited to healthcare facilities or the healthcare industry.

In the healthcare embodiment, server computer 40 may maintain a patient database 104 on storage device 44 coupled to server computer 40. Patient database 104 may define all (or a portion of) the patients currently being cared for within the hospital. Patient database 104 may also contain other associated information, including healthcare-related information such as medical insurance information, laboratory test results and doctor appointment scheduling.

Server computer 34 may execute an ADT application 36 which may track the status of the various patients as they are being treated within the hospital. In order to facilitate the generation and maintenance of patient database 104, document distribution program 42, which may be executed on server computer 40, may monitor HL7 communications between server computer 34 and all other devices connected to networks 14, 32. Such HL7 communications may include defining the patients' status within the hospital (e.g., admitted to, discharged from, and transferred within). Document distribution program 42 may utilize the information received from ADT application 36 to generate or maintain patient database 104. Alternatively, patient database 104 may be generated or maintained on server computer 34.

Server computer 34 may also maintain a healthcare forms database 106 on storage device 38 coupled to server computer 34. Healthcare forms database 106 may define all (or a portion of) the healthcare forms available to or utilized within the hospital.

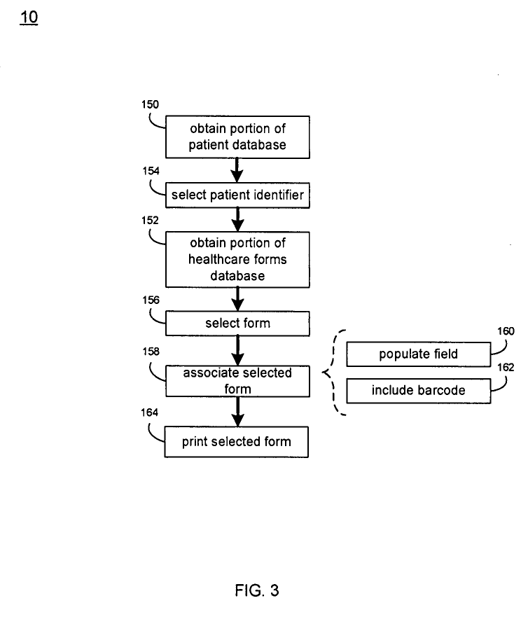

FIG. 3 illustrates a forms management process 10 using the printing system 12 coupled to a distributed computing network. Forms management process 10 may be a Java™ application that is executed locally on printing system 12 utilizing the above-described operating system.

At block 150, printing system 12 obtains a plurality of patient identifiers 18 (defined within storage device 20 of printing system 12), which may represent a portion of patient database 104 that is obtained from remote storage device 44 via network 14 and/or network 32. Patient identifiers may include the identification of patients as well as patient related information corresponding to such patients. For example, if printing system 12 is located within the maternity ward of the hospital, the plurality of patient identifiers 18 may represent the portion of patient database 104 that defines the patients that are currently resident within or assigned to the maternity ward of the hospital. Alternatively, the plurality of patient identifiers 18 may include a larger portion of patient database 104. For example, the plurality of patient identifiers 18 may also include the patient identifiers of outpatients currently enrolled within a “healthy baby” service that provides in-house, follow-up care for newborns. Provided that storage capacity and privacy concerns are addressed, the plurality of patient identifiers 18 may define all patients included within patient database 104.

The plurality of patient identifiers 18 may be obtained by printing system 12 through various methodologies, examples of which may include, but are not limited to, the plurality of patient identifiers 18 being pushed by server computer 40 to printing system 12 or the plurality of patient identifiers 18 being pulled from server computer 40 by printing system 12. Updating of patient identifiers in printing system 12 may occur automatically at pre-determined time intervals (e.g., every 8 hours) or upon request by printing system 12.

Updating of the plurality of patient identifiers 18 and associated information defined within printing system 12 may also occur after printing system 12 receives an indication from server 34 or server 40 that data contained in patient database 104 has changed. For example, upon arrival at the hospital, patient “Susan Jones” may be assigned to the admissions department. If she is in labor, she may then be transferred or assigned to the maternity ward. Upon receiving the information about “Susan Jones” being transferred from the admissions department to the maternity ward, document distribution program 42, may update patient database 104 to reflect the change in the status of “Susan Jones”.

Printing system 12 may be notified of differences between patient information stored in patient database 104 and plurality of patient identifiers 18 stored in printing system 12. Such notification may be of a general nature (i.e., a notice that there are differences). Such notification may also be more specific, such as identifying new patients, the patients whose status or information has changed and/or including the specific patient information that has changed.

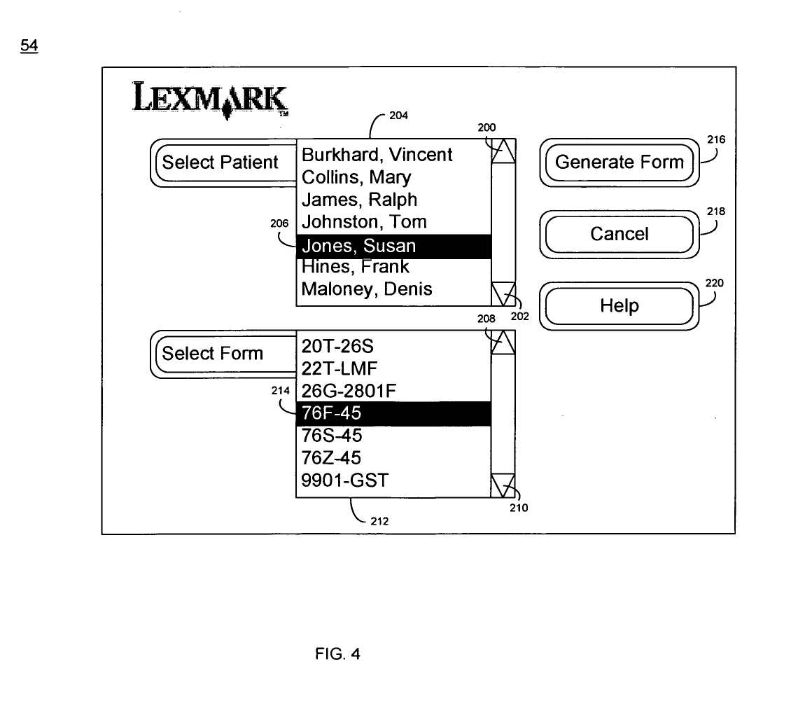

At block 154, user 16 may select a patient identifier chosen from plurality of patient identifiers 18 defined within storage device 20 of printing system 12. Referring to FIG. 4, such selection may occur at display panel 54. Display panel 54 may be a touch-screen display panel that is finger navigatable by user 16. In an alternate embodiment, display panel 54 may be coupled with an I/O device, such as a mouse or keyboard. Continuing with the maternity ward example, a patient named “Susan Jones” has just been transferred to the maternity ward, and an admission form needs to be completed. User 16, who, in this example, is the nurse in charge of patient “Susan Jones” may utilize display panel 54 of printing system 12 to scroll (via up arrow 200 and down arrow 202) through the list 204 of patients currently resident within the maternity ward of the hospital, as defined within plurality of patient identifiers 18, to locate newly-admitted patient “Susan Jones”. Once located, the nurse may select 154 “Susan Jones”, resulting in the “Susan Jones” entry 206 within list 204 becoming indicated in a differentiating manner, such as highlighted or bolded.

Referring back to FIG. 3, at block 152, printing system 12 obtains a plurality of healthcare forms 22 defined within storage device 20 of printing system 12, which may represent a portion of healthcare forms database 106 that is obtained from remote storage device 38 via network 14 and/or network 32. For example, if printing system 12 is located within the maternity ward of the hospital, the plurality of healthcare forms 22 may represent the portion of healthcare forms database 106 that defines the healthcare forms used within the maternity ward of the hospital. Alternatively, the plurality of healthcare forms 22 may define a larger portion of healthcare forms database 106. For example, the plurality of healthcare forms may also include forms used by the pediatrics department of the hospital. Provided that there is sufficient storage capacity, the plurality of healthcare forms 22 may define all healthcare forms available to or utilized by the hospital.

The plurality of healthcare forms 22 may be obtained by printing system 12 through various methodologies, examples of which may include, but are not limited to, the plurality of healthcare forms 22 being pushed by server computer 34 to printing system 12 or the plurality of healthcare forms 22 being pulled from server computer 34 by printing system 12. Updating of the plurality of healthcare forms 22 may occur in any manner similar to the updating of the patient identifiers 18, as described above.

At block 156, user 16 may select a form chosen from the plurality of healthcare forms 22 defined within storage device 20 of printing system 12. Referring once again to FIG. 4, user 16 may select the appropriate form using display panel 54. For example, if general admissions form 76F-45 needs to be filled out by the nurse in charge of patient “Susan Jones”, the nurse may utilize display panel 54 of printing system 12 to scroll (via up arrow 208 and down arrow 210) through the list 212 of healthcare forms, as defined within the plurality of healthcare forms 22, to locate general admissions form 76F-45. Once located, the nurse may select 156 “76F-45”, resulting in the “76F-45” entry 214 within list 212 becoming indicated in a differentiated manner, such highlighted or bolded.

Once the desired patient identifier (e.g., “Susan Jones”) is selected (at block 154) and the desired healthcare form (e.g., “76F-45”) is selected (at block 156), the desired patient identifier may be associated with the selected form at block 158. This association may be initiated automatically upon the selection of both the desired healthcare form and desired patient identifier. This association may also be initiated by a specific request from user 16. For example, as seen in FIG. 4, user 16 may activate or select the “Generate Form” button 216 on display panel 54 to initiate the modification or association of the selected form with the selected patient. In the event user 16 wishes to cancel modified form generation or seek additional assistance, user 16 may select a “Cancel” button 218 or a “Help” button 220, as appropriate.

At block 158, the selected form may then be modified or associated with the information corresponding to the selected patient identifier in various ways. For example, at least one field within the selected form may be filled or automatically populated with information associated with the selected identifier and stored in from identifier database 104 (block 160). In the maternity ward example, a general admission form may include fields for defining the patient's first name, the patient's last name, the patient's social security number, and the patient's medical insurance carrier.

Accordingly, when associating the selected form with the selected patient (i.e., “Susan Jones”), the first name field of the form may be populated with “Susan”; the last name field of the form may be populated with “Jones”; the social security number field of the form may be populated with “123-45-6789”; and the medical insurance carrier field of the form may be populated 160 with “XYZ Medical Insurance Corporation”, thus defining modified selected form 24. The information used to populate these fields may be extracted from the patient information associated with the patient identifier for “Susan Jones”, as defined within the plurality of patient identifiers 18.

In an alternate embodiment, modifying the selected form may include associating a machine readable barcode corresponding to the selected patient identifier (block 162). The machine readable barcode included within modified selected form 24 may be subsequently printed or scanned (by a barcode scanner; not shown).

At block 164, modified selected form 24 may be printed on printing system 12. Modified selected form 24 may be stored within storage device 20 of printing system 12 for subsequent retrieval and printing 164. Accordingly, assume for illustrative purposes that a copy of modified selected form “76F-45” needs to be filed out every time that there is a shift change (e.g., every eight hours or every twelve hours). Since modified selected form 24 may be stored within storage device 20 of printing system 12 for subsequent retrieval and printing, printing system 12 will not need to repeatedly associate the selected form with the selected patient. Additionally, as user 16 may store within storage device 20 of printing system 12 a plurality of different modified selected forms, a repository of modified selected forms may be defined for subsequent retrieval and printing 164.

The foregoing description has been presented for purposes of illustration. It is not intended to be exhaustive or to limit the invention to the precise steps and/or forms disclosed, and obviously many modifications and variations are possible in light of the above teaching. Further, it will be appreciated by one having ordinary skill in the art that various changes in the elements and their configuration and arrangement are possible without departing from the spirit and scope of the present invention. It is intended that the scope of the present invention be defined by the claims appended hereto.

What is claimed is:

1. A method, comprising:
selecting an identifier chosen from a plurality of identifiers defined within a storage device of a printing system;
selecting a form chosen from a plurality of forms defined within the storage device of the printing system; and
associating the selected form with the selected identifier, thus defining a modified selected form.

2. The method of claim 1, further comprising:
printing the modified selected form on the printing system.

3. The method of claim 1, wherein the plurality of identifiers are defined within at least a portion of an information database included within the storage device of the printing system.

4. The method of claim 3, further comprising:
obtaining the at least a portion of the database from a remote network storage device.

5. The method of claim 1 wherein the plurality of forms are defined within at least a portion of a forms database included within the storage device of the printing system.

6. The method of claim 5 further comprising:
obtaining the at least a portion of the forms database from a remote network storage device.

7. The method of claim 1 wherein the storage device of the printing system is an internal storage device included within the printing system.

8. The method of claim 1, wherein modifying the selected form includes at least one of:
modifying the selected form to include information associated with the selected identifier within at least one populatable field within the selected form; and
modifying the selected form to include a machine readable barcode associated with the selected patient identifier.

9. A computer program product residing on a computer readable medium having a plurality of instructions stored thereon which, when executed by a processor, cause the processor to perform operations, comprising:
selecting an identifier chosen from a plurality of identifiers defined within a storage device of a printing system;
selecting a form chosen from a plurality of forms defined within the storage device of the printing system; and
modifying the selected form to associate the selected form with the selected identifier, thus defining a modified selected form.

10. The computer program product of claim 9, further comprising instructions for:
printing the modified selected form on the printing system.

11. The computer program product of claim 9, wherein the plurality of identifiers are defined within at least a portion of an information database included within the storage device of the printing system.

12. The computer program product of claim 11, further comprising instructions for obtaining the at least a portion of the information database from a remote network storage device.

13. The computer program product of claim 9, wherein the plurality of forms are defined within at least a portion of a forms database included within the storage device of the printing system.

14. The computer program product of claim 13, further comprising instructions for obtaining the at least a portion of the forms database from a remote network storage device.

15. The computer program product of claim 9, wherein the storage device of the printing system is an internal storage device included within the printing system.

16. The computer program product of claim 9, wherein the instructions for modifying the selected form includes instructions for at least one of:
modifying the selected form to include information associated with the selected identifier within at least one populatable field within the selected form; and
modifying the selected form to include a machine readable barcode associated with the selected identifier.

17. A printing system, comprising:
a storage device for defining a plurality of identifiers and a plurality of forms;
a user interface configured to allow a user to:
select an identifier chosen from the plurality of identifiers defined within the storage device of the printing system, and
select a form chosen from the plurality of forms defined within the storage device of the printing system; and
processing logic configured to associate the selected form with the selected identifier, thus defining a modified selected form.

18. The printing system of claim 17, wherein the plurality of forms are defined within at least a portion of a forms database included within the storage device of the printing system.

19. The printing system of claim 18, further comprising:
a network interface configured to interface with a distributed computing network and obtain the at least a portion of the forms database from a remote network storage device.

20. The printing system of claim 17, wherein the processing logic is further configured to perform one or more of:
modifying the selected form to include information associated with the selected identifier within at least one populatable field within the selected form; and
modifying the selected form to include a machine readable barcode associated with the selected identifier.
